(19) United States
(12) Patent Application Publication
(10) Pub. No.: US 2013/0206131 A1
(43) Pub. Date: Aug. 15, 2013

(54) FIRE ENCLOSURE

(71) Applicant: Charles Hood, Reno, NV (US)

(72) Inventor: Charles Hood, Reno, NV (US)

(21) Appl. No.: 13/370,823

(22) Filed: Feb. 10, 2012

(51) Int. Cl. A47J 37/07

(52) U.S. Cl. 126/25 R

(57) ABSTRACT

A fire enclosure includes a roof supported by a frame. The frame includes openings through which the interior of the fire enclosure is visible. The openings can be covered by at least two overlapping screens. The screens can be oriented to slope downward and inward from the roof.

### BACKGROUND

Many people enjoy sitting around a fire with family and friends relaxing, telling stories, and roasting marshmallows. These experiences strengthen social bonds and create fond memories that last a lifetime. It is an uplifting experience that provides grounding and balance moving forward.

The fire is essential part of this experience. It provides contrast with the surroundings that frees up one's thoughts, especially at night when the fire pierces the darkness and reflects off the nearby trees with the moon and stars overhead. It also serves as a visual focal point that invites conversation and reduces worries about how comments are interpreted. It encourages reflection on and sharing of past experiences for everyone to experience.

The fire can be contained in a number of ways. One of the most common ways is with a fire ring, which is a circle of loose, inflammable material such as rocks. The most common example of a fire ring is a ring of loose rock found at campgrounds and similar locations. Other common ways to contain the fire is with a fire pit, fireplace (portable or fixed) or chimnea.

One of the risks associated with an open fire is the risk that it will spread and turn into a wildfire. One of the most common ways an open fire spreads is by burning embers that land nearby on something flammable such as dry grass, pine needles, and the like.

In an effort to combat this problem, federal, state, and local governments have passed laws that restrict or outright ban open fires in certain areas. This is especially true in national forests and other similar areas that are high risk.

### SUMMARY

A number of representative embodiments are provided to illustrate the various features, characteristics, and advantages of the disclosed subject matter. It should be understood, however, that the various concepts can be used in settings, situations, and configurations other than those explicitly shown. For example, the features, characteristics, advantages, etc., for each embodiment can be used alone or in various combinations and sub-combinations with one another.

A fire enclosure is disclosed that includes a roof and a frame. The roof is supported by the frame and prevents rain and snow from getting inside. The fire enclosure also prevents burning embers from exiting the interior of the enclosure and causing a fire hazard. It has an aesthetically pleasing appearance both when a fire is burning inside and when it is not being used.

The fire enclosure includes one or more openings in the frame through which the fire is visible. In one embodiment, the openings are covered by at least two overlapping screens. This reduces the chance of a burning ember escaping from the enclosure since the embers. The innermost screen stops most embers, but the few that make it through are stopped by the next screen.

The fire enclosure includes one or more doors that open to provide access to the interior. The doors are used to add firewood to the fire, clean out the ashes, and the like. The doors can include one or more screens and cover the openings in the frame. In one embodiment, the doors are mounted on pins that are part of the frame. The doors can be easily removed by lifting the doors off the pins.

The fire enclosure can be shaped to further reduce the likelihood of embers escaping from the enclosure. In one embodiment, the one or more screens slope downward and inward from the roof toward the interior of the enclosure (or upward and outward from the bottom towards the roof). The frame may also have this shape, which, in one configuration is similar to an inverted, three dimensional pyramid.

The effectiveness of the screens is maximized when the screens are positioned parallel to the direction of travel of the hot gases. The hot gases in which the embers are entrained don't travel straight upward. Instead, they travel upward and outward from the fire. Slightly tilting the screens makes it so the embers travel parallel to the screens. This makes it harder for the embers to escape since they must make a large change in direction (i.e., right angle turn) to pass through the openings in the screens.

The fire enclosure can be part of a permanent fire pit or it can be a portable unit that is easily transported and used in different locations. In one embodiment, the fire enclosure is portable and includes a base coupled the bottom of the frame. The base is supported above the ground by legs coupled to the underside of the base. The base can include fire brick to prevent the underside of the base from getting too hot and killing or igniting vegetation or other flammable material that may be under the base.

In another embodiment, the fire enclosure is coupled to a permanent base positioned on the ground. The base includes a hole for a fire and a raised portion that surrounds the hole. Examples of such a base include rings of stone and rock held together with grout or the like. The fire enclosure is coupled to the base and encloses the hole.

The Summary is provided to introduce a selection of concepts in a simplified form that are further described below in the Detailed Description. The Summary and the Background are not intended to identify key concepts or essential aspects of the disclosed subject matter, nor should they be used to constrict or limit the scope of the claims. For example, the scope of the claims should not be limited based on whether the recited subject matter includes any or all aspects noted in the Summary and/or addresses any of the issues noted in the Background.

### DRAWINGS

The preferred and other embodiments are disclosed in association with the accompanying drawings in which:

FIG. 1 is a perspective view of a fire pit that includes a fire enclosure coupled to a permanent base.

FIG. 2 is a perspective view of the fire enclosure from FIG. 1 with two of the doors open.

FIG. 3 is an exploded perspective view of one of the doors from the fire enclosure in FIG. 1.

FIG. 4 is a perspective view of the roof showing the adjustable vent openings.

FIG. 5 is a perspective view of the base of the fire pit from FIG. 1.

FIG. 6 is a perspective view of the base of the fire pit with particular focus on the fire grates that support the fire in the hole.

FIGS. 7-8 show how the fire enclosure is coupled to the base of the fire pit.

FIGS. 9-12 are perspective views of a portable fire enclosure.

FIG. 13 is a perspective view of the base of the portable fire enclosure.

### DETAILED DESCRIPTION

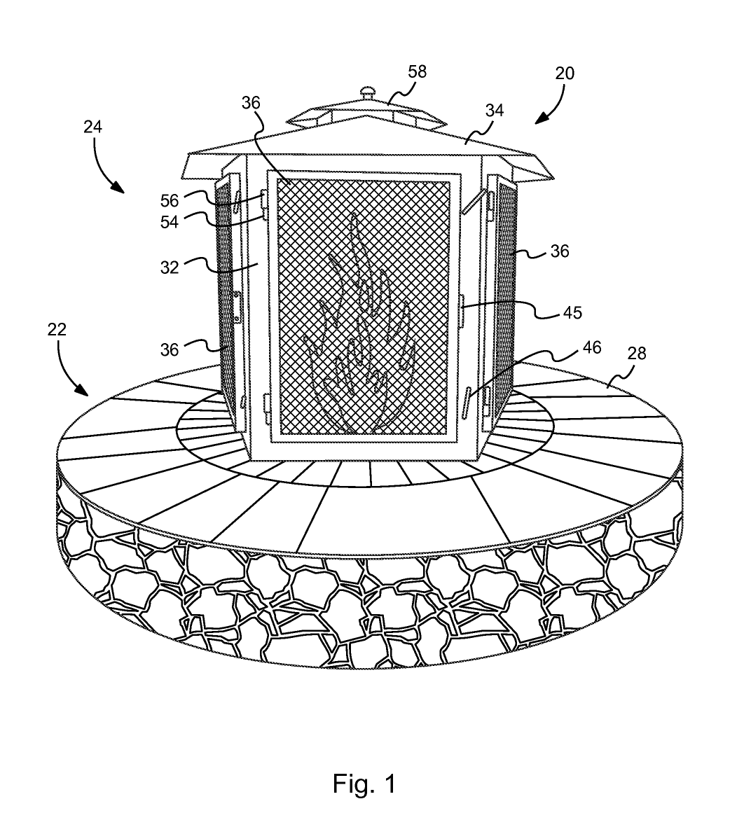

FIG. 1 shows a fire enclosure 20 coupled to a permanent base 22 to form a fire pit 24. The fire pit 24 is the type commonly found in the backyards of homes and cabins. It provides a focal point for people to gather around and enjoy the warmth of the fire and the relaxing atmosphere it creates.

The fire pit 24 is considered permanent because the base 22 is built on the ground and cannot be easily moved. Although the base 22 probably could be moved if one's determination was great enough, it was not intended to be moved when it was built, it cannot be moved intact without specialized construction equipment, and the same difficult process must be repeated each time it is moved. For these reasons, the base 22 and the fire pit 24 are considered permanent and not portable. The terms “permanent” and “portable” are defined to be consistent with this understanding.

The base 22 includes a hole 26 for the fire and a raised portion 28 that surrounds the hole 26. The hole 26 confines the fire and acts as a barrier to keep the fire from spreading beyond the base 22. The raised portion 28 defines the hole 26 and creates a nice area for people to set items or to sit on.

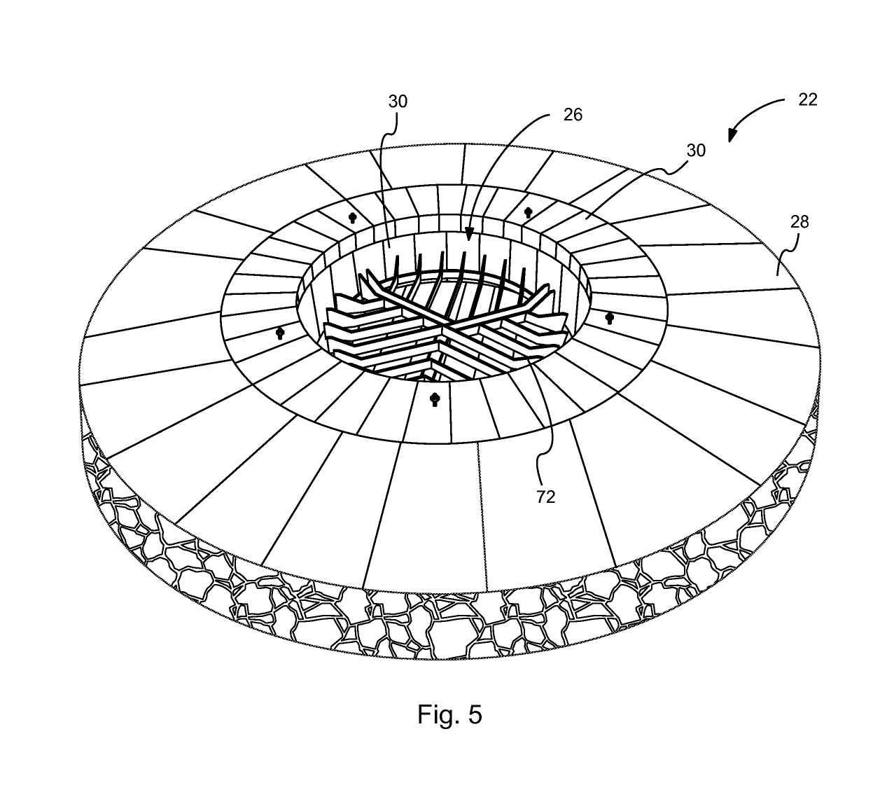

The hole 26 can be lined with fire brick 30 (FIG. 5) to better withstand the heat produced by the fire. The fire brick 30 can form the bottom, sides, and/or rim of the hole 26. The remainder of the base 22 can be made from fire brick or some other non-flammable materials such as stones, rocks, bricks, cement, and so forth.

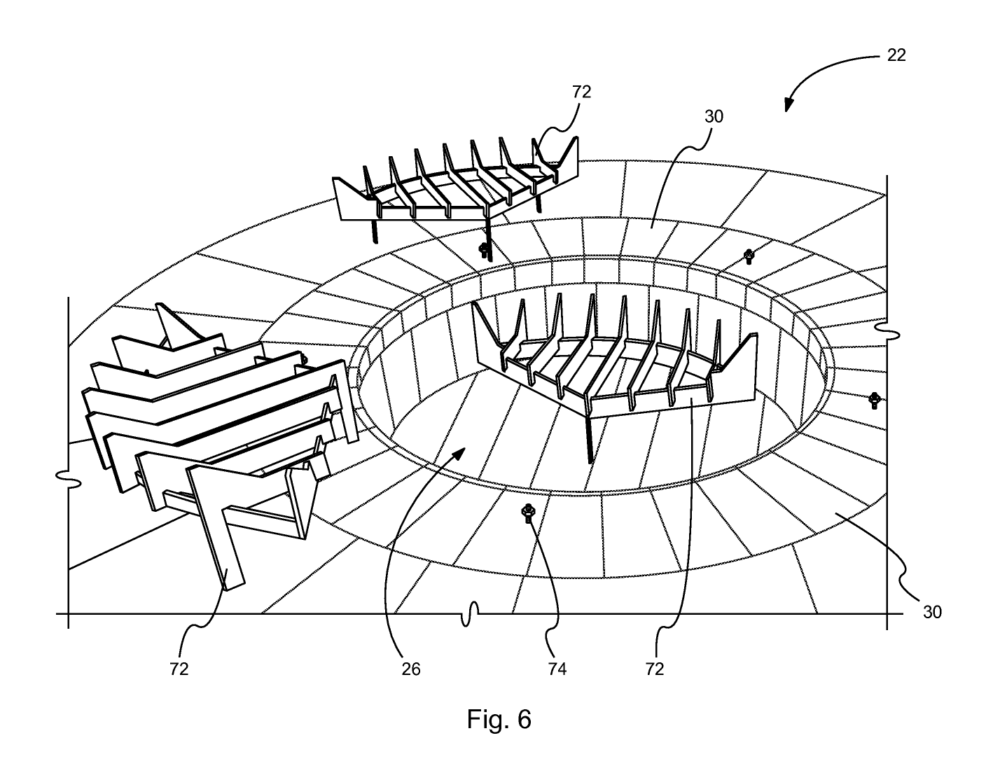

A fire grate 72 can be positioned in the hole 26 to create a more efficient fire. The fire grate 72 holds the wood off the ground thereby allowing oxygen to get underneath the wood, which creates a hotter fire and reduces the amount of smoke emitted. The fire grate 72 can be formed by combining multiple pieces together as shown in FIG. 6. Since the fire grate 72 is usually made of thick metal, it is easier to transport as separate pieces.

The base 22 can have any suitable size and shape. In one embodiment, the outer diameter (or largest dimension for non-circular shapes) of the base 22 is approximately 3 feet to approximately 15 feet, the diameter of the hole 26 is approximately 18 inches to approximately 96 inches, and the height of the raised portion is 6 inches to 30 inches. The base 22 shown in the figures has a circular shape, but it can also be octagonal, triangular, or the like. Also, the base 22 can be configured so that the hole 26 is recessed into the ground and the raised portion is absent.

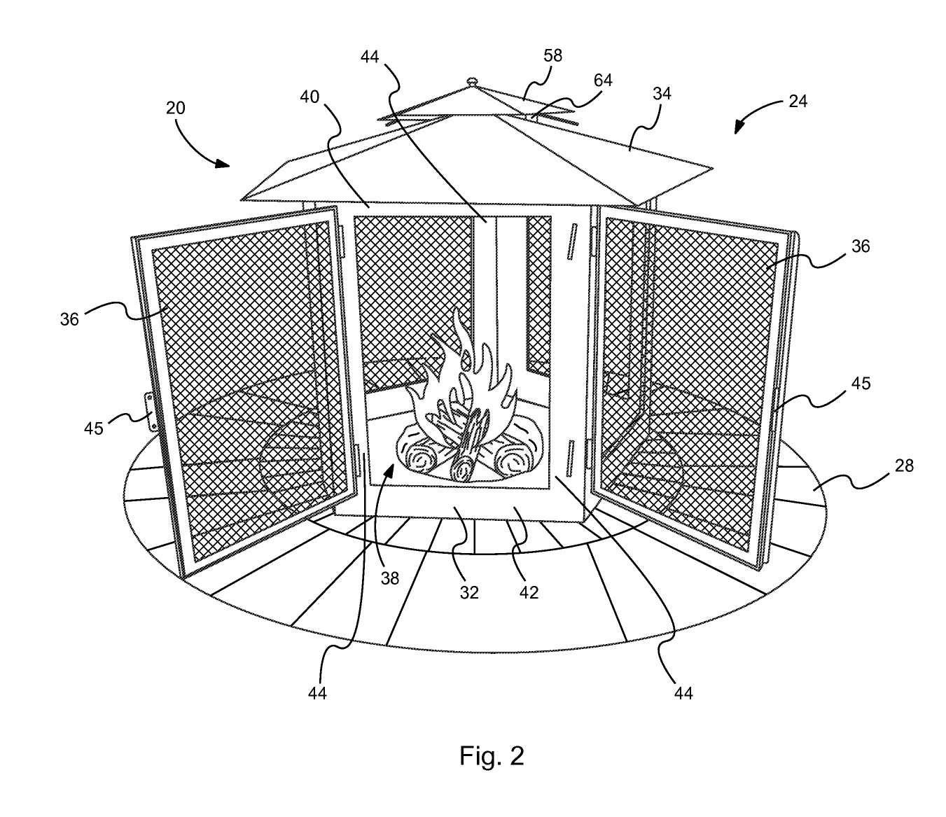

The fire enclosure 20 includes a frame 32, a roof 34 supported by the fame 32, and multiple doors 36 coupled to the frame 32. The fire enclosure 20 is shown coupled to the base 22 to form the fire pit 24 in FIGS. 1-2. The enclosure 20 prevents the fire from spreading beyond its boundaries by preventing burning embers and the like from escaping while still providing a visually appealing experience to nearby users.

It should be noted that for purposes of this disclosure, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature.

The frame 32 is a free-standing structure that provides an overall framework for the rest of the components of the fire enclosure 20. The frame 32 includes openings 38 through which the fire is visible. The frame 32 includes upper cross beams 40, lower cross beams 42, and support posts 44, which define the boundaries of the openings 38. It should be appreciated that the cross beams 40, 42 and support posts 44 may not correspond to physically separate pieces of the frame 32, but correspond to certain areas of the frame 32.

The frame 32 includes five planar sides or walls that form a pentagon with an opening 38 in each side. It should be appreciated that the frame 32 can have any suitable shape such as other polygonal shapes—e.g., hexagon, square, rectangular, and the like—or it can be round, elliptical, and the like.

The frame 32 is roughly vertical in FIGS. 1-2, which means that the upper cross beams 40 are directly above the lower cross beams 42 and the support posts 44 extend straight up. It should be appreciated, however, that the frame 32 can be inclined inwardly or outwardly. For example, the frame 32 can slope downward and inward from the roof 34 toward the base 22 thereby forming an inverted pyramid shape (or upward and outward from the base 22 towards the roof 34).

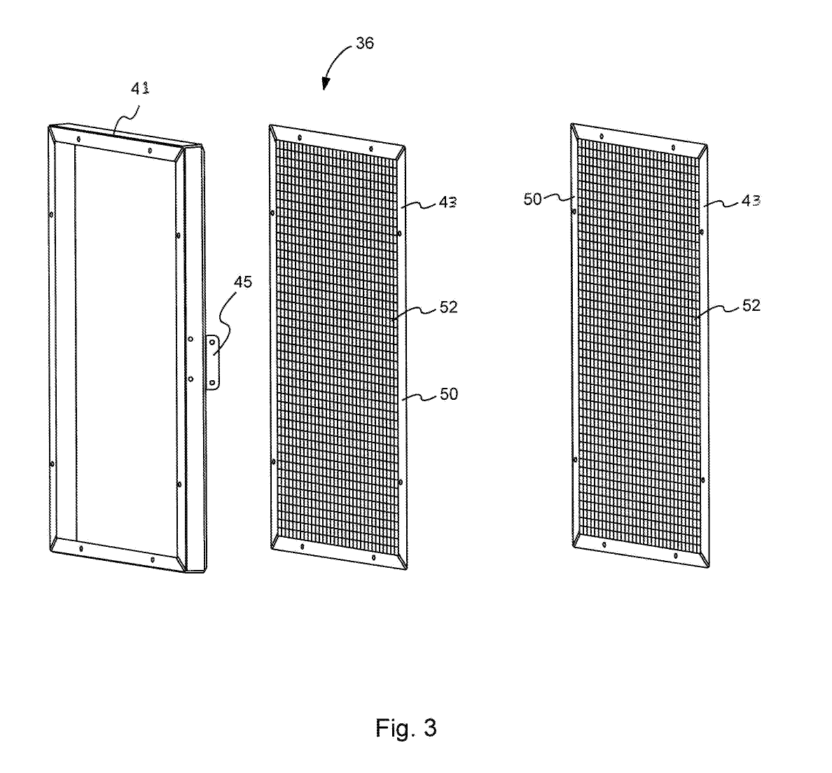

The openings 38 are covered by doors 36 that pivot open as shown in FIG. 2. Referring to FIG. 3, each door 36 includes a frame 41, screens 43 coupled to the frame 41, and a handle 45. The handle 45 allows the user to easily grasp the door 36 to open and close it.

The screens 43 each include a frame 50 and a mesh material 52 enclosed in the frame 50. The mesh material 52 can be any suitable non-flammable material that has openings small enough to prevent embers from exiting the fire enclosure 20. It may be desirable to use more durable mesh material in situations where the fire enclosure 20 is open for public use and subject to a greater risk of vandalism. In one embodiment, the mesh material is wire mesh material having a mesh size of approximately 8 mesh to approximately 40 mesh and a wire size of approximately 0.009 inches to 0.075 inches.

The screens 43 are spaced apart in the frame 41 of the door 36. This can be accomplished in a number of ways such as, for example, with spacers positioned between the screens 43. The screens 43 can also be spaced apart in the frame 41 any suitable distance. In one embodiment, the screens are spaced apart approximately 0.125 inches to approximately 1.5 inches or approximately 0.25 inches to approximately 1 inch.

The use of two screens 43 positioned in series reduces the possibility of a burning ember escaping from the fire enclosure 20. The first or inner screen 43 stops the majority of embers and the second or outer screen 43 stops the rest. It should be appreciated that in alternative embodiments, the doors 36 can include a single screen 43 or more than two screens 43.

The doors 36 move between an open position (FIG. 2) and a closed position (FIG. 1). The doors 36 are held in the closed position by handles 46 coupled to the support posts 44. The handles 46 move between a first position where the handles 46 prevent the door 36 from opening (upper handle 46 in FIG. 1) and a second position where the handles 46 allow the door 36 to open (lower handle 46 in FIG. 1).

The doors 36 include sleeves 56 that engage pins (or mounting pins) 54 on the frame 32. The weight of the doors 36 keeps the sleeves 56 from coming off the pins 54. The doors 36 pivot on a vertical axis defined by the pins 54 as the doors 36 move between the open position and the closed position. The doors 36 can be easily coupled to and decoupled from the frame 32 by lifting the doors 36 so that the sleeves 56 disengage the pins 54.

In an alternative embodiment, the pins 54 can be oriented in opposite directions (e.g., one pin 54 pointing down and the other pin 54 pointing up) so that the only way to remove the doors 36 from the frame 32 is to remove one of the pins 54. It should be appreciated that the position of the pins 54 and the sleeves 56 can be reversed so that the pins are coupled to the doors 36 and the sleeves are part of the frame 32.

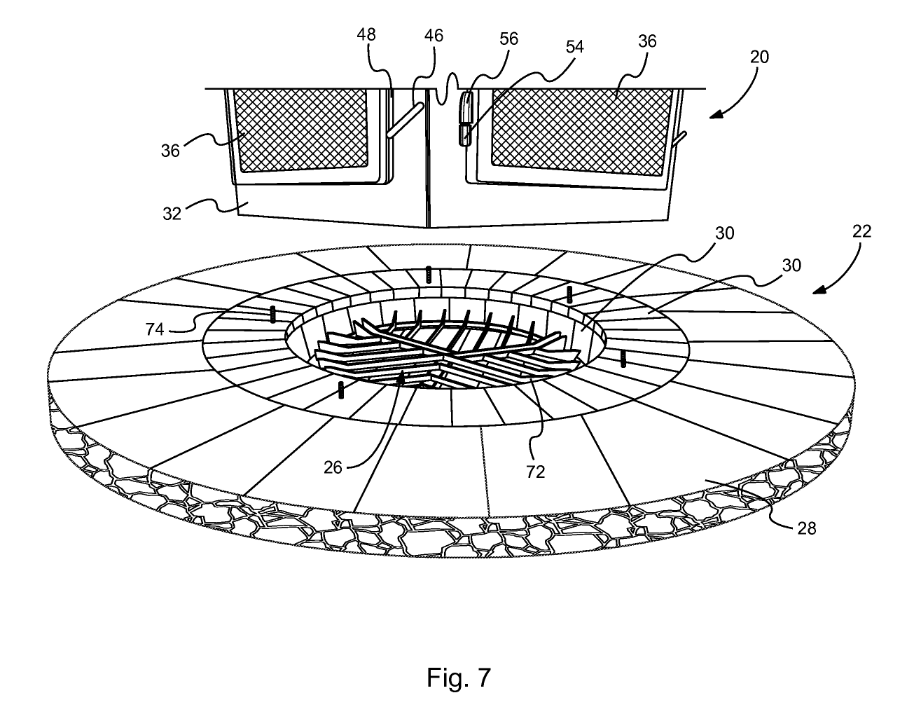

Referring to FIG. 7, the door frame 41 includes a lip or flange 48 extending vertically adjacent to the handles 46. The handles 46 pivot between the first position where the handle 46 is oriented at a downward sloping angle towards the door 36 so that the bottom end of the handle 46 is over the lip 48 thereby preventing the door 36 from opening and the second position where the handle 46 is oriented vertically so that the bottom end of the handle 46 is not over the lip 48 thereby allowing the door 36 to open. It should be appreciated that the door 36 can be secured in a closed position in a variety of ways.

The fire enclosure 20 shown in FIGS. 1-2 has five doors 36, one on each side of the enclosure 20. It should be appreciated, however, that the fire enclosure 20 can have any suitable number of doors 36 in any configuration. For example, the fire enclosure 20 can include a single door 36 and the rest of the openings 38 can be covered with immovable screens 43.

In one embodiment, all of the openings on the sides of the fire enclosure 20 are covered by at least one screen 43 and, preferably, at least two, spaced apart screens 43. For example, the frame 32 may only include the openings 38 and they are all covered by one or more screens 43.

The fire enclosure 20 can also include baffles (not shown) coupled to the underside of the roof 34 or the upper cross beams 40. The baffles extend lengthwise parallel to the roof 34 and outward in a direction that is towards the bottom of the door 36 on the opposite side of the fire enclosure 20. As the fire burns, the hot gases hit the roof 34 and travel down the underside until it reaches the screens 43 in the doors 36. The baffles redirect the gases back toward the interior of the fire enclosure 20 thereby preventing them from directly impacting the screens 43 at the top of the doors 36.

The fire enclosure 20 shown in FIGS. 1-2 is designed so that the fire in the interior is visible from 360° around the enclosure 20. It should be appreciated, however, that the fire enclosure 20 can be designed so that the interior is only visible from 270° or 180° around the enclosure 20. This can be accomplished by making a portion of the side of the enclosure 20 solid. For example, one or more sides of the frame 32 may be formed of solid material that is not see-through.

The roof 34 includes one or more vent openings 60, which are covered by a roof cap 58 which prevents water from entering the enclosure 20 through the vent openings 60. The roof 34 is sloped so that water runs off the sides and does not enter the fire enclosure 20. The interior stays dry and puddles cannot form in the hole 26 after a rain or snow storm. This makes it so the fire enclosure 20 is always ready to be used regardless of the weather conditions.

The roof 34 and the roof cap 58 have complementary designs that provide an aesthetically pleasing appearance. Specifically, the roof cap 58 is shaped similarly to the roof 34, but smaller since it only needs to cover the vent openings 60.

Smoke exits the fire enclosure 20 through the vent openings 60 in the roof 34. The roof cap 58 forces the smoke to make at least a 90° turn to get past the roof cap 58. The tortuous path that the smoke must travel to get out of the fire enclosure 20 helps prevent burning embers from exiting through the roof 34.

The burning embers are entrained in the smoke stream but don't change directions as quickly as the smoke. This causes the embers to exit the smoke stream and hit the underside of the roof cap 58 and/or the top of the roof 34 thereby removing them from the smoke stream. Also, the impact has a tendency to put the embers out so that they are no longer burning.

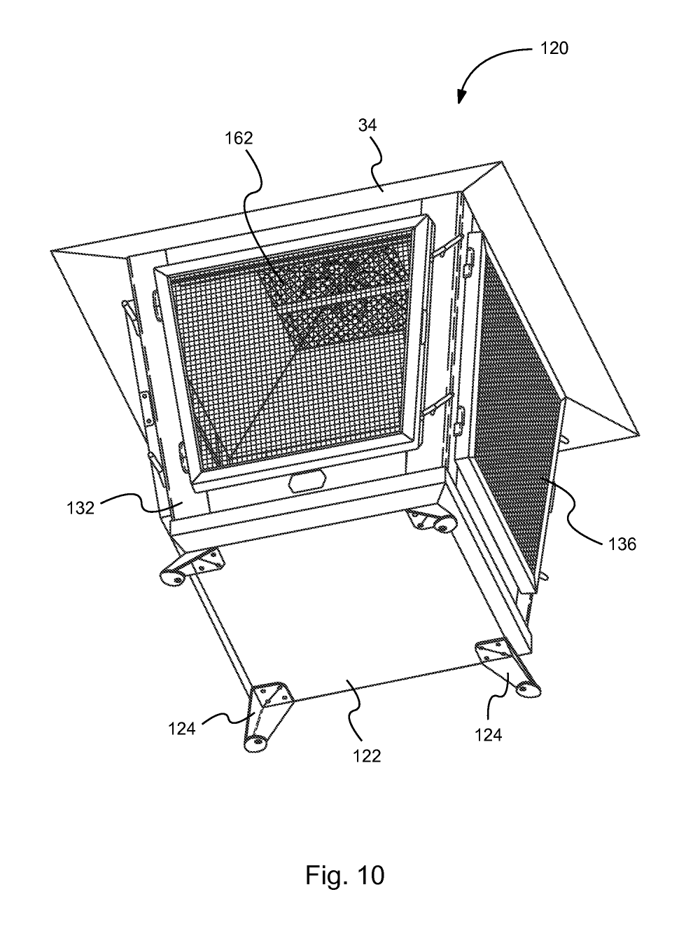

One or more screens can also be positioned to cover the vent openings 60 to further reduce the chance of burning embers escaping from the fire enclosure 20 (FIG. 10). The screens can be similar or identical to the screens 43 described above.

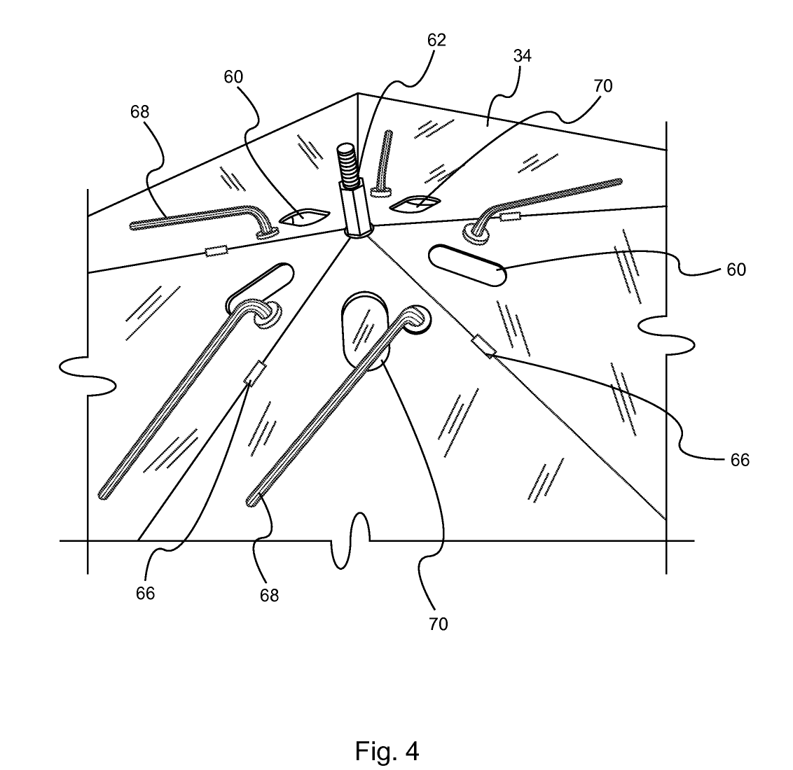

Turning to FIG. 4, the roof cap 58 is coupled to support member 62 that extends upward from the peak of the roof 34. The threaded portion of the support member 62 extends through a hole in the top of the roof cap 58 and engages a threaded nut or the like, which holds the roof cap 58 in place. The threaded nut can have a decorative design to provide an aesthetically pleasing appearance.

The roof cap 58 is also supported by support struts 64 (FIG. 2) positioned between the roof cap 58 and the roof 34. The support struts 64 engage slots 66 in the roof 34 that hold the support struts 64 in place.

The size of the vent openings 60 can be adjusted with the vent handles 68, which are coupled to vent dampers 70. When the vent handle 68 is in the position shown at the bottom of FIG. 4, the corresponding vent opening 60 is completely closed. However, when the vent handle 68 is positioned parallel to the roof lines (see vent handles 68 adjacent to the closed vent handle 68) then the vent opening 60 is completely open.

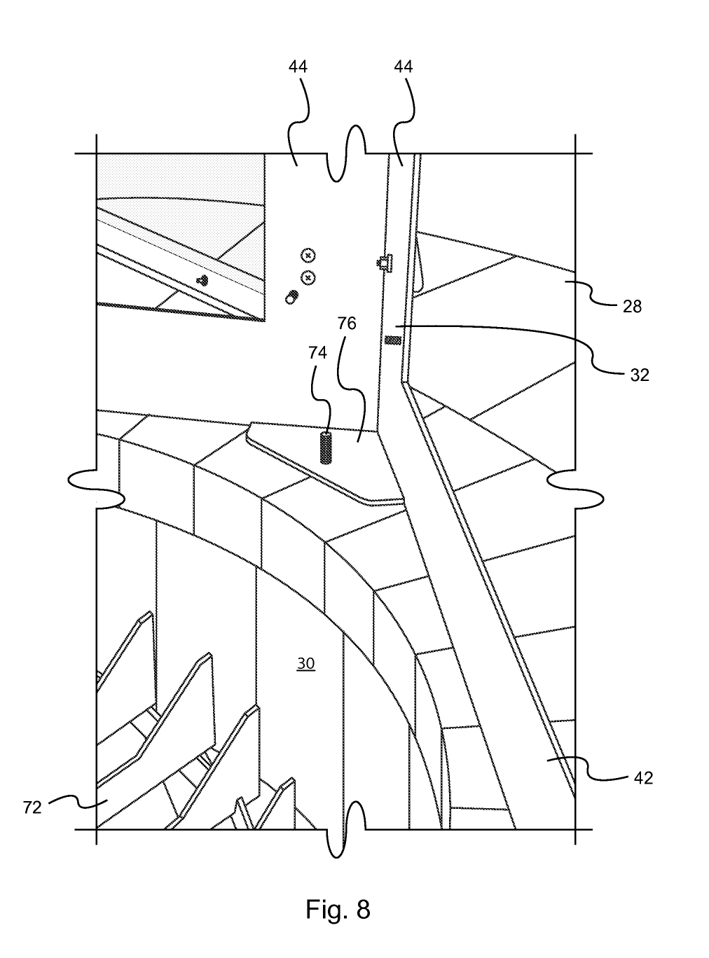

The fire enclosure 20 is coupled to the base 22 in the manner shown in FIGS. 7-8. Flanges 76 are positioned on the underside of the frame 32 at each corner. The flanges 76 increase the structural strength of the frame 32 and include holes that are used to couple the frame to the base 22. Anchors 74 are positioned in the base 22 at locations that correspond to the holes in the frame 32. The fire enclosure 20 is lowered on to the base so that the anchors 74 extend through the holes in the frame. The fire enclosure 20 is then fastened to the base 22.

In one embodiment, the anchors 74 are bolts that are configured to be embedded in the base. Corresponding nuts are placed on the bolts to fasten the fire enclosure 20 to the base 22. It should be appreciated that numerous other techniques can be used to couple the fire enclosure 20 to the base 22.

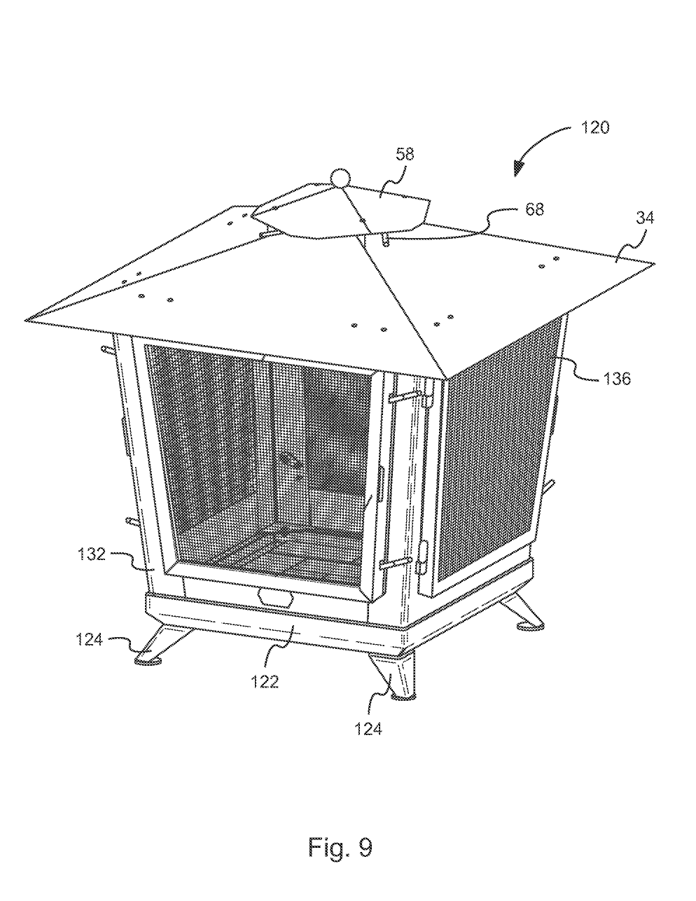

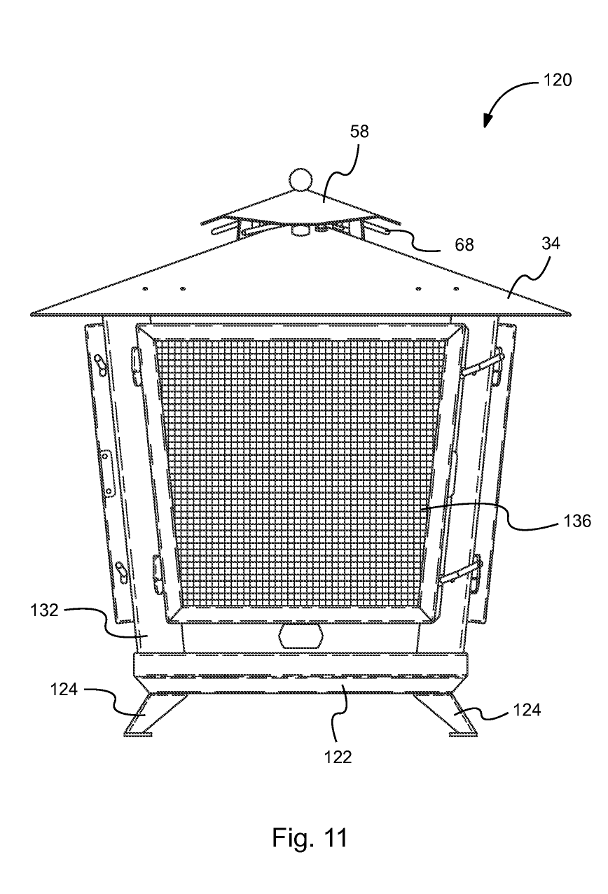

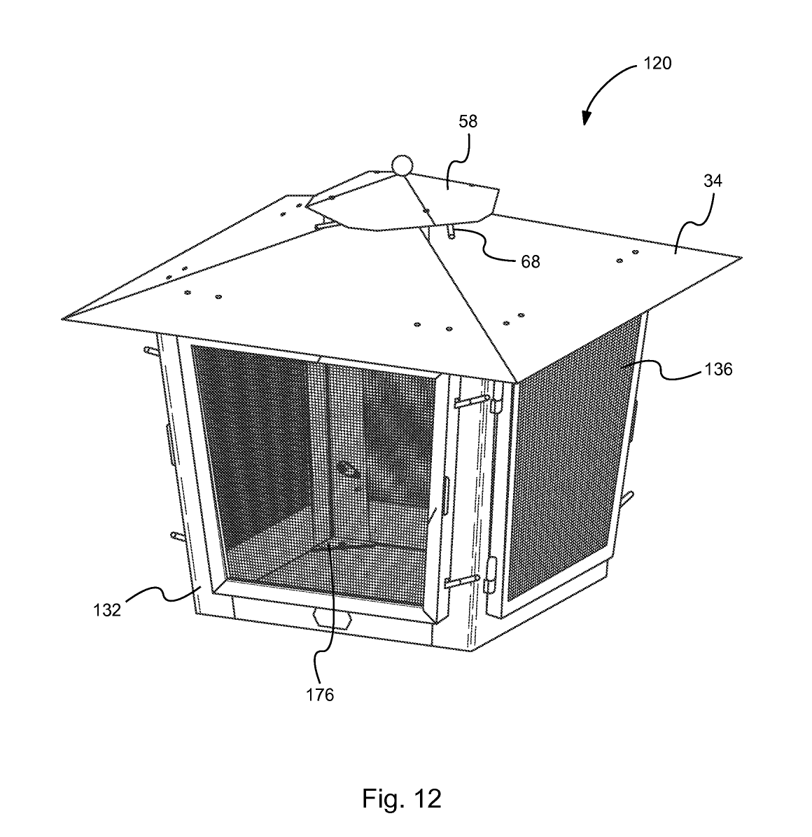

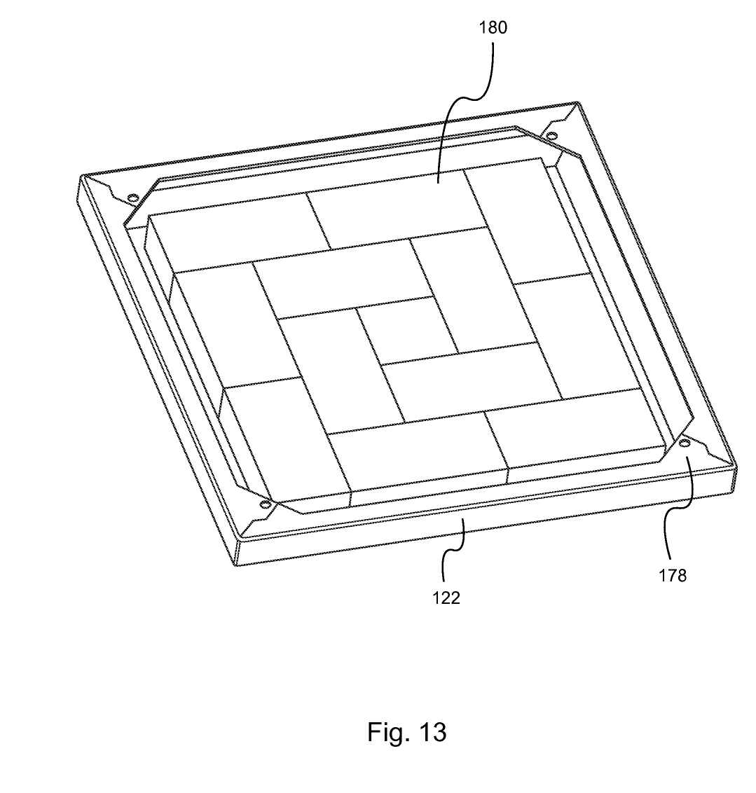

Turning to FIGS. 9-13 another embodiment of a fire enclosure 120 is depicted. This embodiment differs from the previous one in that the fire enclosure 120 is configured to be portable. For example, the fire enclosure 120 may be placed on a patio, deck, or lawn during use and then stored elsewhere.

The fire enclosure 120 is similar in many ways to the fire enclosure 20. For example, they both share the same or similar roofs 34 and roof caps 58. The other details associated with the roof 34 such as the venting are also the same. It should be appreciated that, unless noted otherwise, the details described in connection with the fire enclosure 20 apply equally to the fire enclosure 120.

FIG. 10 shows a screen 162 covering the vent openings in the roof 34. The screen is positioned underneath the roof 34 at the top of the interior of the fire enclosure. The screen 162 helps prevent burning embers from escaping from the fire enclosure 120. It should be appreciated that the screen 162 can be replaced by multiple screens or eliminated entirely depending on the embodiment. Also, the screen 162 can be configured in any of the ways described above in connection with the other screens or otherwise have any of the characteristics and features of the screens.

The fire enclosure 120 includes a frame 132 and doors 136. These are similar to the frame 32 and doors 36 of the fire enclosure 20 except that their overall shape has been modified so that they slope upward and outward from the bottom towards the roof 134. The benefits of this design are discussed above.

The fire enclosure 120 includes a portable base 122 coupled to the bottom of the frame 132. The base 122 includes legs 124 that hold the base 122 in a raised position off the ground. The base 122 is coupled to the frame 132 using fasteners that extend through holes in flanges 176 on the bottom of the frame 176 and corresponding flanges 178 on the top of the base 122.

The base 122 includes a layer of fire brick 180 or other non-flammable material on which the fire can burn. The fire brick 180 helps protect whatever is under the fire enclosure 120 from being damaged by excessive heat. For example, the fire brick 180 may protect grass under the fire enclosure from dying or a wood patio from getting too hot and catching fire.

The fire enclosures 20, 120 can be made out of any suitable material that is capable of withstanding high temperatures such as those associated with an outdoor fire. Examples of such materials include the many grades of steels and other metals and metal allows. In one embodiment, the fire enclosures 20, 120 are made of cold finished steel and/or stainless steel. For example, the screens, handles, pins, vent covers, etc., can be made of stainless steel and the rest of the enclosures 20, 120 can be made of cold finished steel.

The steel can be covered with a protective coating such as paint to prevent rust and other forms of corrosion. In one embodiment, the paint is capable of withstanding temperatures up to 1600° F. An example of such a paint is a high temperature ceramic paint. Powder coating can also be used, but it can only withstand temperatures up to 1200° F.

Illustrative Embodiments

Reference is made in the following to a number of illustrative embodiments of the disclosed subject matter. The following embodiments illustrate only a few selected embodiments that may include one or more of the various features, characteristics, and advantages of the disclosed subject matter. Accordingly, the following embodiments should not be considered as being comprehensive of all of the possible embodiments.

The concepts and aspects of one embodiment may apply equally to one or more other embodiments or may be used in combination with any of the concepts and aspects from the other embodiments. Any combination of any of the disclosed subject matter is contemplated.

In one embodiment, a fire enclosure comprises a frame, a roof supported by the frame, and at least one opening in the frame through which the interior of the fire enclosure is visible. The opening can be covered by at least two overlapping screens. The screens can be spaced apart from each other 0.125 inches to 2 inches.

The fire enclosure can include a door coupled to the frame to provide access to the interior of the fire enclosure. The screens can be in the door and the opening can be covered by the door. The door can be coupled to pins on the frame and the door can be decoupled from the frame by lifting the door upward off the pins.

The screens can be configured so that the openings in one of the screens is offset from the openings in another one of the screens. The frame can include at least two openings through which the interior of the fire enclosure is visible. Each of the openings can be covered by at least two overlapping screens. The openings can be covered by a door and each door includes the screens.

The screens can slope downward and inward from the roof toward the interior of the fire enclosure. The frame can also slope downward and inward from the roof toward the interior of the fire enclosure.

The fire enclosure can be portable or part of a permanent fire pit. In one embodiment, a fire pit comprises the fire enclosure coupled to a permanent base positioned on the ground that includes a hole for a fire and a raised portion that surrounds the hole.

The roof can include at least one vent opening where the size of the vent opening is adjustable. Also all of the openings in the frame through which the interior of the fire enclosure is visible can be covered by at least two overlapping screens.

In another embodiment, the fire enclosure comprises a frame, a roof supported by the frame, and at least one screen covering an opening in the frame through which the interior of the fire enclosure is visible. The screen slopes and inward from the roof toward the interior of the fire enclosure.

All of the screens that cover openings in the frame slope can downward and inward toward the interior of the fire enclosure. The frame can also slope downward and inward toward the interior of the fire enclosure.

In another embodiment, the fire enclosure comprises a frame, a roof supported by the frame, at least one opening in the frame through which the interior of the fire enclosure is visible, and a base coupled to the bottom of the frame. The base includes fire brick. All of the openings in the frame through which the interior of the fire enclosure is visible can be covered by a screen. The fire enclosure can be portable and include legs coupled to the base to support the base above the ground.

In another embodiment, the fire pit comprises a permanent base positioned on the ground. The bas includes a hole for a fire and a raised portion that surrounds the hole. The fire enclosure is coupled to the base and includes a frame, a roof supported by the frame, and at least one opening in the frame through which the interior of the fire enclosure is visible.

The fire brick surrounds the hole. The raised portion can be formed of stone and/or brick. The fire enclosure can be coupled to the base with anchors embedded in the base.

In another embodiment, the fire enclosure comprises a frame, a roof supported by the frame, and a door coupled to pins on the frame. The door is configured to provide access to the interior of the fire enclosure. The door can be separated from the frame by lifting the door upward off the pins. The fire enclosure can include at least two doors coupled to pins on the frame where each door can be separated from the frame by lifting the door upward off the pins.

In another embodiment, the fire enclosure comprises a frame, a roof supported by the frame, and at least one opening in the frame through which the interior of the fire enclosure is visible. The roof can include at least one vent opening, the size of which is adjustable. Also, all of the openings in the frame through which the interior of the fire enclosure is visible can be covered by a screen.

The fire enclosure can include a vent cover having a vent handle. The vent handle moves the vent cover to adjust the size of the vent opening. The vent opening can also be covered by a screen.

In another embodiment, the fire enclosure comprises a frame, a roof supported by the frame, at least two doors each of which covers an opening in the frame through which the interior of the fire enclosure is visible, and at least one screen in each of the doors to keep burning embers from escaping from the interior of the fire enclosure.

The doors provide access to the interior of the fire enclosure. The fire enclosure can include at least three doors each of which covers an opening in the frame through which the interior of the fire enclosure is visible. All of the openings in the frame can be covered by a door that provides access to the interior of the fire enclosure and includes a screen to keep burning embers from escaping from the interior of the fire enclosure.

The terms recited in the claims should be given their ordinary and customary meaning as determined by reference to relevant entries in widely used general dictionaries and/or relevant technical dictionaries, commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used in a manner that is more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure the term shall mean,” etc.).

References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope.

The subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be given their broadest interpretation in view of the prior art and the meaning of the claim terms.

As used herein, spatial or directional terms, such as “left,” “right,” “front,” “back,” and the like, relate to the subject matter as it is shown in the drawings. However, it is to be understood that the described subject matter may assume various alternative orientations and, accordingly, such terms are not to be considered as limiting.

Articles such as “the,” “a,” and “an” can connote the singular or plural. Also, the word “or” when used without a preceding “either” (or other similar language indicating that “or” is unequivocally meant to be exclusive—e.g., only one of x or y, etc.) shall be interpreted to be inclusive (e.g., “x or y” means one or both x or y).

The term “and/or” shall also be interpreted to be inclusive (e.g., “x and/or y” means one or both x or y). In situations where “and/or” or “or” are used as a conjunction for a group of three or more items, the group should be interpreted to include one item alone, all of the items together, or any combination or number of the items. Moreover, terms used in the specification and claims such as have, having, include, and including should be construed to be synonymous with the terms comprise and comprising.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

All ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

What is claimed is:

1. A fire enclosure comprising:
a frame;
a roof supported by the frame; and
at least one opening in the frame through which the interior of the fire enclosure is visible;
wherein the opening is covered by at least two overlapping screens.

2. The fire enclosure of claim 1 wherein the screens are spaced apart from each other at least 0.25 inches.

3. The fire enclosure of claim 1 comprising a door coupled to the frame to provide access to the interior of the fire enclosure, wherein the screens are in the door and the opening is covered by the door.

4. The fire enclosure of claim 3 wherein the door is coupled to pins on the frame so that the door can be decoupled from the frame by lifting the door upward off the pins.

5. The fire enclosure of claim 1 wherein each of the screens includes openings and the openings in one of the screens is offset from the openings in another one of the screens.

6. The fire enclosure of claim 1 wherein the frame includes at least two openings through which the interior of the fire enclosure is visible, wherein each of the openings is covered by at least two overlapping screens.

7. The fire enclosure of claim 6 wherein each of the openings is covered by a door and each door includes the screens.

8. The fire enclosure of claim 1 wherein the screens slope downward and inward from the roof toward the interior of the fire enclosure.

9. The fire enclosure of claim 1 wherein the fire enclosure is portable.

10. A fire pit comprising the fire enclosure of claim 1 coupled to a permanent base positioned on the ground, the base including a hole for a fire and a raised portion that surrounds the hole.

11. The fire enclosure of claim 1 wherein the roof includes at least one vent opening where the size of the vent opening is adjustable.

12. The fire enclosure of claim 1 wherein all of the openings in the frame through which the interior of the fire enclosure is visible are covered by at least two overlapping screens.

13. A fire enclosure comprising:
a frame;
a roof supported by the frame; and
at least one screen covering an opening in the frame through which the interior of the fire enclosure is visible;
wherein the screen slopes downward and inward from the roof toward the interior of the fire enclosure.

14. The fire enclosure of claim 13 wherein all the screens that cover openings on the side of the frame slope downward and inward toward the interior of the fire enclosure.

15. The fire enclosure of claim 13 wherein the frame slopes downward and inward toward the interior of the fire enclosure.

16. A fire enclosure comprising:
a frame;
a roof supported by the frame;
at least one opening in the frame through which the interior of the fire enclosure is visible; and
a base coupled to the bottom of the frame, the base including fire brick;
wherein all of the openings in the frame through which the interior of the fire enclosure is visible are covered by a screen; and
wherein the fire enclosure is portable.

17. The fire enclosure of claim 16 comprising legs coupled to the base to support the base above the ground.

18. A fire pit comprising:
a permanent base positioned on the ground, the base including:
a hole for a fire; and
a raised portion that surrounds the hole;
a fire enclosure coupled to the base, the fire enclosure including:
a frame;
a roof supported by the frame; and
at least one opening in the frame through which the interior of the fire enclosure is visible.

19. The fire pit of claim 18 wherein fire brick surrounds the hole.

20. The fire pit of claim 18 wherein the raised portion is formed of stone and/or brick.

21. The fire pit of claim 18 wherein the fire enclosure is coupled to the base with anchors embedded in the base.
